(19) United States
(12) Patent Application Publication
(10) Pub. No.: US 2013/0177460 A1
(43) Pub. Date: Jul. 11, 2013

(54) Air Pump and Connecting Piece for the Same

(71) Applicant: David Ying Chi Hong, Causeway Bay (HK)

(72) Inventor: David Ying Chi Hong, Causeway Bay (HK)

(21) Appl. No.: 13/443,526

(22) Filed: Apr. 10, 2012

(30) Foreign Application Priority Data
Jan. 9, 2012 (CN) 201220006409.0
Jan. 9, 2012 (HK) 12100219.1

(51) Int. Cl. F04B 17/03; F16B 1/00

(52) U.S. Cl. 417/423.6; 403/205

(57) ABSTRACT

A connecting piece for an air pump comprises a first connecting board and a second connecting board, and the bottom of the first connecting board is connected with the top of the second connecting board. A first mounting hole is set up on the first connecting board, and a compression chamber is mounted in the first mounting hole. A second mounting hole is set up on the second connecting board, and a power device is mounted in the second mounting hole. The first and second mounting holes are both through holes. The air pump includes a power device and a transmission device connected together via the connecting piece.

### CROSS-REFERENCE TO RELATED APPLICATIONS

Pursuant to 35 U.S.C. 119(a), the instant application claims priority to prior Hong Kong application number 12100219.1, filed Jan. 9, 2012; and People's Republic of China application number 201220006409.0, filed Jan. 9, 2012.

### FIELD OF THE INVENTION

The invention is related to connectors, especially involving a connecting piece applied in portable air pumps and one type of air pumps adopting the connecting piece.

### BACKGROUND OF THE INVENTION

Air pump is also named as inflatable pump or inflator, and an air pump normally works based on the operation of a motor. During a gas exhaustion process, check valve of the piston is opened by atmospheric pressure, allowing air entering in the air pump. During the gas filling process, check valve of the piston is closed by internal pressure of the air pump, thus delivering air into tires. Air pumps are widely used in the areas of automobiles, motorcycles and bicycles. It is requested that in an air pump, a connecting piece is used to connect a power device and a transmission device, therefore forming a perpendicular connection between an output shaft in the power device and a transmission shaft in the transmission device. Currently, there are two general types of connecting pieces. For the first type, a plastic structure is adopted, and the drawbacks are fairly long compression chamber, large in volume, and high cost consumption. For the second type, a cast iron structure is adopted, and the drawbacks are fairly long compression chamber, fairly heavy in weight, and high cost consumption.

### SUMMARY OF THE INVENTION

One technical problem to be resolved by the present invention, against those in the prior art having defects such as fairly long compression chamber, large in volume, heavy in weight and high cost, is to provide a connecting piece for an air pump with fairly short compression chamber, small volume, light weight, low cost and easy to cast.

One further technical problem to be resolved by the present invention, against those in the prior art having defects such as fairly long compression chamber, large in volume, heavy in weight and high cost, is to provide one type of air pumps connected by the abovementioned connecting piece.

According to an aspect of the present invention, a connecting piece includes a first connecting board and a second connecting board, and an end of the first connecting board is connected with an end of the second connecting board. In an embodiment, a bottom end of the first connecting board is connected with a top end of the second connecting board. A first mounting hole is set up on the first connecting board. The first mounting hole may be inserted with a compression chamber, fixing the compression chamber with the first connecting board. A second mounting hole is set up on the second connecting board. The second mounting hole may be inserted with a power device, fixing the power device with the second connecting board. The first and second mounting holes are both through holes.

In an embodiment of the present invention, an assisting mounting hole is set up on the second connecting board, and the assisting mounting hole is a through hole.

In an embodiment of the present invention, the bottom of the first connecting board is in perpendicular connection with the top of the second connecting board.

In an embodiment of the present invention, at least a mounting hole is set up on the first and second connecting boards respectively.

According to another aspect of the present invention, an air pump includes a power device and a transmission device, and the power device and transmission device are connected together via the connecting piece described above.

In an embodiment of the present invention, the power device comprises an electric motor, output shaft of which is provided with a first transmission gear. The transmission device comprises a first connecting shaft and a first piston for a connecting rod. The first connecting shaft is fixed at an eccentric point of the first transmission gear, and one end of the first piston is installed in the first connecting shaft and the other end of the first piston is installed with a piston ring. The first piston is installed inside the compression chamber, and the compression chamber is fixed in the first mounting hole. The electric motor is fixed at the second connecting board, and the output shaft goes through the second mounting hole to connect the electric motor with the second connecting board.

In an embodiment of the present invention, a second transmission gear is provided in the assisting mounting hole. The second transmission gear comprises a second connecting shaft installed at the eccentric point of the second transmission gear. Further, a second piston for a connecting rod is installed on the second connecting shaft.

The connecting piece according to the present invention may provide the following beneficial effects: because the first and second connecting boards can be either assembled or integrated as an one-piece device, it has simplified structure, is easy to cast, and has small volume, light weight and low cost consumption. The air pump connected by the connection piece according to the present disclosure is also simple in structure, easy to cast, and has small volume, light weight, and low cost consumption.

### DESCRIPTION OF THE DRAWINGS

The present invention is described in detail with reference to the following figures and embodiments, in which:

FIG. 1 is a schematic diagram of a structure of an air pump in accordance with one embodiment of the present invention;

FIG. 2 is a schematic diagram of a structure of a transmission device in accordance with one embodiment of the present invention;

FIG. 3 is a schematic diagram of a structure of the compression chamber in accordance with one embodiment of the present invention; and

FIG. 4 is a schematic diagram of a structure of a connecting piece in accordance with one embodiment of the present invention.

### DETAILED DESCRIPTION OF THE EMBODIMENTS

To make the objects, technical solutions and advantages of the invention more clear, the illustration below together with figures and embodiments further explains in detail on the present invention. It should be understood that the specific embodiments here are used only to explain the invention, but are not limited to the invention.

As shown in FIG. 4, one embodiment of the present invention provides a connecting piece for an air pump. The connecting piece comprises a first connecting board 20 and a second connecting board 21. Any standard steel plate or flat plate formed by other materials known to those skilled in the art can be used to prepare the first connecting board 20 and the second connecting board 21. An end of the first connecting board 20 connects with an end of the second connecting board 21, referring to FIG. 4, the bottom of the first connecting board 20 is connected with the top of the second connecting board 21. The first connecting board 20 and the second connecting board 21 can be assembled together or integrated into a unibody, providing a simplified structure and being easy to cast. A first mounting hole 22 is set up on the first connecting board 20, based on which a compression chamber is fixed on the first connecting board 20. That is, the compression chamber goes through the first mounting hole 22 to couple with the first connecting board 20. A second mounting hole 23 is set up on the second connecting board 21, through which an output shaft of a power device goes and connects the power device with the second connecting board 21. The first and second mounting holes 22, 23 are both through holes.

Advantageously, an assisting mounting hole 24 is set up on the second connecting board 21 which is a through hole. The assisting mounting hole 24 may be used to install other devices, such as a transmission gear in transmission device.

Advantageously, the bottom of the first connecting board 20 is in perpendicular connection with the top of the second connecting board 21. The function of connecting boards is to alter the transmission direction of a power provided by the power device. While the output shaft in the power device is in a vertical direction, through the transmission system, the power can be output in a horizontal shaft.

Advantageously, at least a first mounting hole and at least a second mounting hole are set up on the first connecting board 20 and the second connecting board 21 separately to fix the compression chamber and the power device respectively.

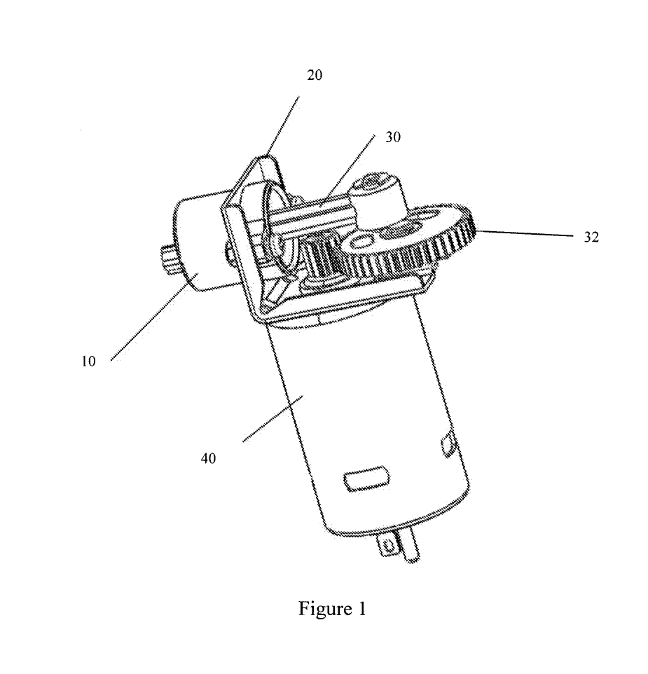

As shown in FIG. 1, one embodiment of the present invention provides an air pump. The air pump comprises a power device and a transmission device, and the power device and the transmission device are connected together via the connecting piece.

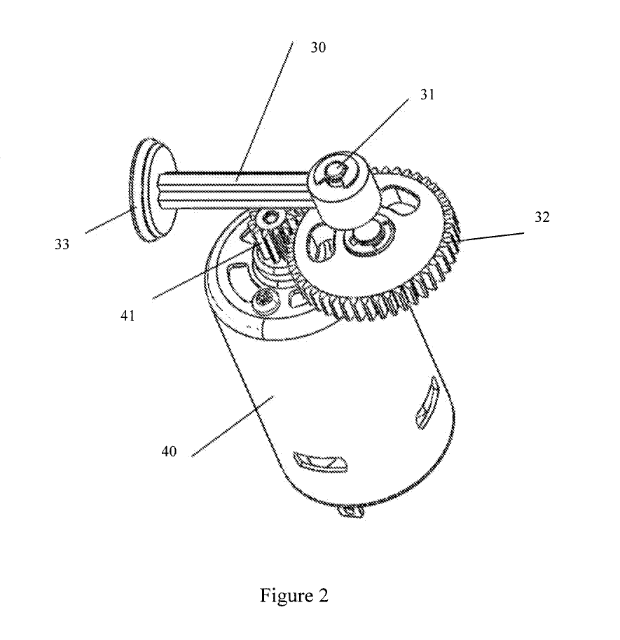

As shown in FIGS. 1, 2, an electric motor 40 is applied to be the power device in the present invention. A first transmission gear 41 is installed in the output shaft of the electric motor 40. The transmission device of the present invention comprises a first connecting shaft and a first piston for a connecting rod, further one end of the first connecting shaft is fixed at an eccentric point of the first transmission gear 41. The eccentric point can be any point between the center point and the periphery in the circular surface of the first transmission gear 41. One end of the first piston is coupled with the first connecting shaft so that the first piston can rotate freely around the first connecting shaft. And the other end of the first piston is installed with a piston ring. The first piston is installed in the compression chamber 10, and the compression chamber 10 is installed in the first mounting hole 22, thus connecting the compression chamber 10 with the first connecting board 20. The electric motor 40 is fixed at the second connecting board 21, and the output shaft of the electric motor 40 passes through the second mounting hole 23 to connect the second connecting board 21 with the electric motor 40.

Advantageously, a second transmission gear 32 is installed in the assisting mounting hole 24. A second connecting shaft 31 is installed at an eccentric point of the second transmission gear 32, further a second piston 30 for another connecting rod is provided on the connecting shaft 31. The function of the second transmission gear 32 is to reduce speed, and the transmission between the first transmission gear 41 and the second transmission gear 32 can be adjusted in accordance with operating frequencies of the pistons.

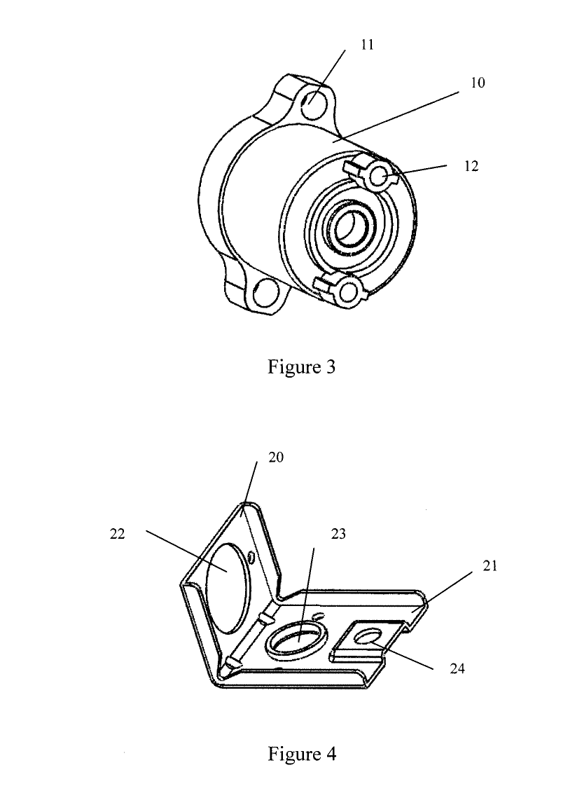

At least one first connecting hole and second connecting hole can be provided in the compression chamber 10. As shown in FIG. 3, two first connecting holes 12 are set up at the front of the compression chamber 10, and the compression chamber 10 is fixed with other object through connection fasteners known in the art. Two second connecting holes 11 are set up at the rear end of the chamber 10, and the compression chamber 10 is fixed at the first connecting board 20 through connection fasteners known in the art.

In an embodiment, the operation process of the air pump is disclosed in the following words. The first transmission gear 41 connected with the output shaft in the electric motor 40 drives the second transmission gear 32, and the second connecting shaft 31 which is installed on the second transmission gear 32 rotates according to the rotation of the second transmission gear 32, then the second piston 30 is in a reciprocating motion between the peak point and lowest point.

It should be understood that technicians in this field can further improve or change the usage in accordance with the above statement, but all the improvements and changes should be within the right of protection scope of the invention.

What is claimed is:

1. An connecting piece comprising a first connecting board and a second connecting board, and the bottom of the first connecting board is connected with the top of the second connecting board; a first mounting hole is set up on the first connecting board, and a second mounting hole is set up on the second connecting board; and the first mounting hole and the second mounting hole are both through holes.

2. The connecting piece according to claim 1, wherein a compression chamber is fixed with the first connecting board via the first mounting hole, and a power device is fixed with the second connection board via the second mounting hole.

3. The connecting piece according to claim 1, wherein an assisting hole is set up on the second connecting board, and the assisting hole is a through hole.

4. The connecting piece according to claim 1, wherein the bottom of the first connecting board is in perpendicular connection with the top of the second connecting board.

5. The air pump connecting piece according to claim 1, wherein at least one mounting hole is set up on the first connecting board and the second connecting board respectively.

6. An air pump including a power device and a transmission device, the power device and the transmission device being connected together via the connecting piece of claim 1.

7. The air pump according to claim 6, wherein the power device is an electric motor; a first transmission gear is installed on an output shaft of the electric motor; the transmission device comprises a first connecting shaft and a first piston for a connecting rod; the first connecting shaft is fixed at an eccentric point of the first transmission gear; one end of the first piston is installed on the first connecting shaft with the other end being installed with a piston ring; the first piston is installed in the compression chamber, and the compression chamber is installed in the first mounting hole; the electric motor is fixed at the second connecting board, and the output shaft of the electric motor passes through the power device mounting hole.

8. The air pump according to claim 7, wherein a second transmission gear is installed in the assisting mounting hole; the second transmission gear comprises a second connecting shaft installed at an eccentric point of the second transmission gear; and the second connecting shaft is installed with a second piston for another connecting rod.
